(19) United States
(12) Patent Application Publication
(10) Pub. No.: US 2019/0060993 A1
(43) Pub. Date: Feb. 28, 2019

(54) AGGLOMERATED PARTICLE POWDER FOR ADDITIVE MANUFACTURING

(71) Applicant: Desktop Metal, Inc., Burlington, MA (US)

(72) Inventors: Animesh Bose, Burlington, MA (US); Jonah Samuel Myerberg, Lexington, MA (US)

(21) Appl. No.: 15/692,921

(22) Filed: Aug. 31, 2017

(51) Int. Cl. B22F 1/00; B33Y 70/00

(52) U.S. Cl. CPC B22F 1/0096; B33Y 70/00; B22F 1/0062; B22F 1/0048

(57) ABSTRACT

Devices, systems, and methods are directed at spreading sequential layers of powder across a powder bed and applying energy to each layer to form a three-dimensional object. The powder can include granules including agglomerations of metallic particles to facilitate spreading the metallic particles in each layer. The energy can be directed to the powder to reflow the granules in each layer to bind the metallic particles in the layer to one another and to one or more adjacent layers to form the three-dimensional object. Thus, in general, the agglomeration of the metallic particles in the granules can overcome constraints associated with metallic particles that are of a size ordinarily unsuitable for flowing and/or a size that presents safety risks. By overcoming these constraints, the granules can improve formation of dense finished parts from a powder and can result in formation of unique microstructures in finished parts.

### BACKGROUND

Binder jetting is an additive manufacturing technique based on the use of a liquid binder to join particles of a powder to form a three-dimensional object. In particular, a controlled pattern of the liquid binder is applied to successive layers of the powder in a powder bed such that the layers of the material adhere to one another form a three-dimensional green part. Through subsequent processing, the three-dimensional green part can be formed into a finished three-dimensional part.

Generally, the density of the finished three-dimensional part is a function of the size of the particles of the powder, in addition to the sintering temperature and time. At the same sintering temperature and hold time, smaller particle sizes typically result in a higher density finished three-dimensional part than larger particle sizes. In fabrication techniques such as binder jetting, however, the need to spread the powder imposes physical constraints on the lower limit of the size of the particles that can be used in the powder. That is, while finer powders are useful for producing higher density parts, the need to spread the powder requires the use of coarser powder that, in turn, produces less dense parts. Accordingly, in certain three-dimensional fabrication techniques, there remains a need to overcome the tradeoff that exists with respect to the ability to spread a powder and the density of a finished part formed from the powder.

### SUMMARY

Devices, systems, and methods are directed at spreading sequential layers of powder across a powder bed and applying energy to each layer to form a three-dimensional object. The powder can include granules including agglomerations of metallic particles to facilitate spreading the metallic particles in each layer. The energy can be directed to the powder to reflow the granules in each layer to bind the metallic particles in the layer to one another and to one or more adjacent layers to form the three-dimensional object. Thus, in general, the agglomeration of the metallic particles in the granules can overcome constraints associated with metallic particles that are of a size ordinarily unsuitable for flowing and/or a size that presents safety risks. By overcoming these constraints, the granules can improve formation of dense finished parts from a powder and can result in formation of unique microstructures in finished parts.

In one aspect, an additive manufacturing method disclosed herein includes spreading a layer of a powder across a powder bed, the powder including granules, and each granule including an agglomeration of first metallic particles in at least one component of a binder system, reflowing the granules along a predetermined two-dimensional pattern in the layer, the at least one component of the binder system from the reflowed granules binding the first metallic particles in the layer to one another and to one or more adjacent layer, and repeating the steps of spreading and reflowing for each layer of a plurality of sequential layers to form a three-dimensional object in the powder bed.

In certain implementations, the at least one component of the binder system can have a melt temperature of greater than about 100° C. and less than about a melt temperature of the first metallic particles. Further, or instead, a temperature difference between the melt temperature of the at least one component of the binder system and a burn off temperature of the at least one component of the binder system can be between about 100° C. and about 300° C.

In some implementations, reflowing the granules along the predetermined two-dimensional pattern in the layer can include chemically dissolving the at least one component of the binder system agglomerating the first metallic particles in the granules. For example, reflowing the granules along the predetermined two-dimensional pattern in the layer can include, from a printhead moving across the powder bed, jetting a liquid including a solvent of the at least one component of the binder system. As a more specific example, the at least one component of the binder system can be water soluble, and the solvent jetted from the printhead can include water. Additionally, or alternatively, the solvent jetted from the printhead can include one or more of hexane, alcohol, and limonene. Further or instead, the binder system can include a first component and a second component (e.g., different from the first component), the first component agglomerating the first metallic particles in the granules, and the liquid jetted from the printhead including the second component. In some instances, the second component have cross-link the first component. In certain instances, the first component and the second component can have different melt temperatures. As an example of a binder system including the first component and the second component, the first component can include one of polyethylene glycol, peracetic acid, and polylactic acid, and the second component of the binder system can include another one of polyethylene glycol, peracetic acid, and polylactic acid.

In certain implementations, reflowing the granules along the predetermined two-dimensional pattern in the layer can include, in the granules, thermally dissolving the at least one component of the binder system. As an example, thermally dissolving the binder of the granules can include directing thermal energy from a laser to the granules along the predetermined two-dimensional pattern. The thermal energy can be controlled, for example, to heat the granules along the predetermined two-dimensional pattern to a temperature greater than a melt temperature of the at least one component of the binder system and less than a burn off temperature of the at least one component of the binder system.

In some implementations, the at least one component of the binder system can include an organic binder.

In certain implementations, the at least one component of the binder system can include one or more polymers. For example, the at least one component of the binder system can include one or more of polyethylene glycol, polyethylene, polylactic acid, polyacrylic acid, and polypropylene.

In some implementations, a volume percentage of the binder system in the three-dimensional object can be about one-third.

In certain implementations, the first metallic particles can include a plurality of metals alloyable with one another. For example, the plurality of metals can include two or more of tungsten, copper, nickel, cobalt, and iron.

In some implementations, the first metallic particles in respective granules can be lightly sintered to one another.

In certain implementations, the powder can further include second metallic particles mixed with the granules, and the at least one component of the binder system from the reflowed granules can bind the first metallic particles and the second metallic particles in the layer to one another and to the one or more adjacent layers. Further, or instead, the granules and the second metallic particles can be substantially uniformly distributed in each layer of the plurality of sequential layers. Additionally, or alternatively, the first metallic particles can have an average particle size smaller than an average particle size of the second metallic particles. As an example, the second metallic particles can have an average particle size in a microparticle range. As a further or alternative example, the first metallic particles can have an average particle size of about 1 micron to about 5 microns. Further, or instead, the first metallic particles can have an average particle size in a nanoparticle range.

In some implementations, the first metallic particles can include a first material, and the second metallic particles can include a second material different from the first material and alloyable with the first material. The first material can include, for example, a metal matrix composite. Further, or instead, the first material can have a first hardness, the second material can have a second hardness, and the second hardness is less than the first hardness. Additionally, or alternatively, the first material and the second material are alloyable with one another to form steel. As an example, the second material can be iron or stainless steel. As an alternative or additional example, the first material can be one or more of tungsten carbide, tungsten carbide-cobalt, and molybdenum. In certain instances, an alloy formed of the first material and the second material has a smaller grain structure than an alloy formed of the second material alone.

In certain implementations, the first metallic particles can include a first material, and the second metallic particles can include a second material different from the first material and unalloyable with the first material. For example, first material can include tungsten and the second material can include copper. Additionally, or alternatively, the first material can include molybdenum and the second material can include copper.

In some implementations, the granules can have an average particle size of greater than about 20 microns and less than about 100 microns.

According another aspect, a powder for additive manufacturing of a three-dimensional object disclosed herein includes first metallic particles, and at least one component of a binder system, the first metallic particles agglomerated in the at least one component of the binder system in the form of discrete granules flowable relative to one another to form a layer having a thickness greater than about 30 microns and less than about 70 microns.

In some implementations, the first metallic particles can have an average particle size of greater than about 1 micron and less than about 5 microns. Additionally, or alternatively, the first metallic particles have an average particle size in a nanoparticle range.

In certain implementations, the discrete granules can have an average particle size of greater than about 20 microns and less than about 100 microns. Further, or instead, the discrete granules can be substantially spherical.

In some implementations, the first metallic particles can include a plurality of materials alloyable with one another. For example, the plurality of materials can include two or more of tungsten, copper, nickel, cobalt, and iron.

In certain implementations, the first metallic particles in respective granules can be lightly sintered to one another.

In some implementations, the at least one component of the binder system can be water soluble to reflow the at least one component of the binder system in the discrete granules.

In certain implementations, the at least one component of the binder system can be soluble in one or more of hexane, alcohol, and limonene to reflow the at least one component of the binder system in the discrete granules.

In some implementations, the at least one component of the binder system can include an organic binder.

In certain implementations, the at least one component of the binder system can include one or more polymers. For example, the at least one component of the binder can include one or more of polyethylene glycol, polyethylene, polylactic acid, polyacrylic acid, and polypropylene.

In some implementations, the at least one component of the binder system can have a melt temperature of greater than about 100° C. and less than a melt temperature of the first metallic particles. Further, or instead, a temperature difference between the melt temperature of the at least one component of the binder system and a burn off temperature of the at least one component of the binder system can be between about 100° C. and about 300° C.

In certain implementations, the powder can further include second metallic particles. For example, the discrete granules can be dispersed in the second metallic particles in a flowable mixture. The second metallic particles can have, in certain instances, an average particle size greater than an average particle size of the first metallic particles. The first metallic particles can include a first material, and the second metallic particles can include a second material different from the first material and alloyable with the first material. For example, the first material can include a metal matrix composite. Additionally, or alternatively, the first material can have a higher hardness than the second material. Further, or instead, an alloy including the first material and the second material can have a smaller grain structure than an alloy formed of the second material alone.

In certain implementations, the second material and the first material can be alloyable with one another to form steel. For example, the second material can include iron. Further, or instead, the first material can include one or more of tungsten carbide, tungsten carbide-cobalt, and molybdenum.

In some implementations, the second metallic particles can have an average particle size in a microparticle range.

In certain implementations, the discrete granules can have a first angle of repose, the second metallic particles can have a second angle of repose, and the first angle of repose and the second angle of repose can be substantially equal.

In some implementations, the first metallic particles can include a first material and the second metallic particles can include a second material different from the first material, the first material and the second material unalloyable with one another. For example, the first material can include a metal matrix composite. Additionally, or alternatively, first material can have a higher hardness than the second material.

According to another aspect, a three-dimensional object disclosed herein includes a plurality of layers, each layer defining a respective two-dimensional pattern, particles dispersed in each layer, the particles including a plurality of different materials, and a binder system including at least one component, the binder system binding the particles in each layer to one another and to one or more adjacent layers, and the three-dimensional object sinterable to form a brown part having microstructures of at least one of the plurality of different materials distributed in a matrix of at least another one of the plurality of different materials.

In certain implementations, the different materials of the plurality of different materials can alloyable with one another.

In some implementations, the particles can include first metallic particles and second metallic particles, the first metallic particles having an average particle size less than an average particle size of the second metallic particles. For example, the second metallic particles can have an average particle size in a microparticle range. Additionally, or alternatively, the first metallic particles can have an average particle size of about 1 micron to about 5 microns. Further, or instead, the first metallic particles can have an average particle size in a nanoparticle range.

In certain implementations, each layer can have a thickness of about 50 microns.

In some implementations, at least one of the plurality of different materials can be harder than at least another one of the plurality of different materials.

In certain implementations, at least one of the plurality of different materials can include a metal matrix composite.

In some implementations, an alloy formed of the plurality of different materials can have a smaller grain structure than an alloy formed of at least one of the plurality of materials alone.

In certain implementations, the plurality of different materials can be alloyable with one another to form steel. For example, at least one of the plurality of different materials can include iron. Additionally, or alternatively, at least one of the plurality of different materials can include one or more of tungsten carbide, tungsten carbide-cobalt, and molybdenum.

In some implementations, the different materials of the plurality of different materials can be unalloyable with one another. For example, at least one of the plurality of different materials can include tungsten. Further, or instead, at least one of the plurality of different materials can include one or more of tungsten, molybdenum, and copper.

In certain implementations, the at least one component of the binder system can include an organic binder.

In some implementations, the at least one component of the binder system can include one or more polymers. For example, the at least one component of the binder system can include one or more of polyethylene glycol, polyethylene, polylactic acid, polyacrylic acid, and polypropylene.

In certain implementations, the at least one component of the binder system can be soluble in water.

In some implementations, the at least one component of the binder system can be soluble in one or more of hexane, alcohol, and limonene.

In certain implementations, the at least one component of the binder system can have a melt temperature of greater than about 100° C. and less than a melt temperature of the plurality of different materials. Further, or instead, a temperature difference between the melt temperature of the at least component of the binder system and a burn off temperature of the at least one component of the binder system can be between about 100° C. and about 300° C.

In some implementations, the at least one component of the binder system can include a first component and a second component, and the first component is different from the second component. For example, the first component and the second component can have different melt temperatures. Further, or instead, the first component and the second component can be cross-linked with one another.

In certain implementations, a volume percentage of the binder system in the three-dimensional object can be about one-third.

### BRIEF DESCRIPTION OF THE DRAWINGS

The systems and methods described herein are set forth in the appended claims. However, for the purpose of explanation, several implementations are set forth in the following drawings:

FIG. 1A is a schematic representation of an additive manufacturing system for forming a three-dimensional object.

FIG. 1B is an enlarged view of a powder useable with the additive manufacturing system of FIG. 1A to form a three-dimensional object, the powder including granules.

FIG. 2 is a flow chart of an exemplary method of selectively reflowing granules of a powder to form a three-dimensional object.

FIG. 3 is a schematic representation of an additive manufacturing plant including the additive manufacturing system of FIG. 1.

FIG. 4 is an enlarged view of a powder useable with the additive manufacturing system of FIG. 1A to form a three-dimensional object, with the powder including granules and second metallic particles.

FIG. 5 is a graphical representation of volumetric percentages of components of the powder of FIG. 4 in implementations in which a binder system is introduced into a three-dimensional object exclusively through granules of the powder and the target concentration of the binder in the three-dimensional object is 33 percent.

FIG. 6 is a schematic representation of an additive manufacturing system for forming a three-dimensional object.

### DESCRIPTION

Embodiments will now be described with reference to the accompanying figures. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms.

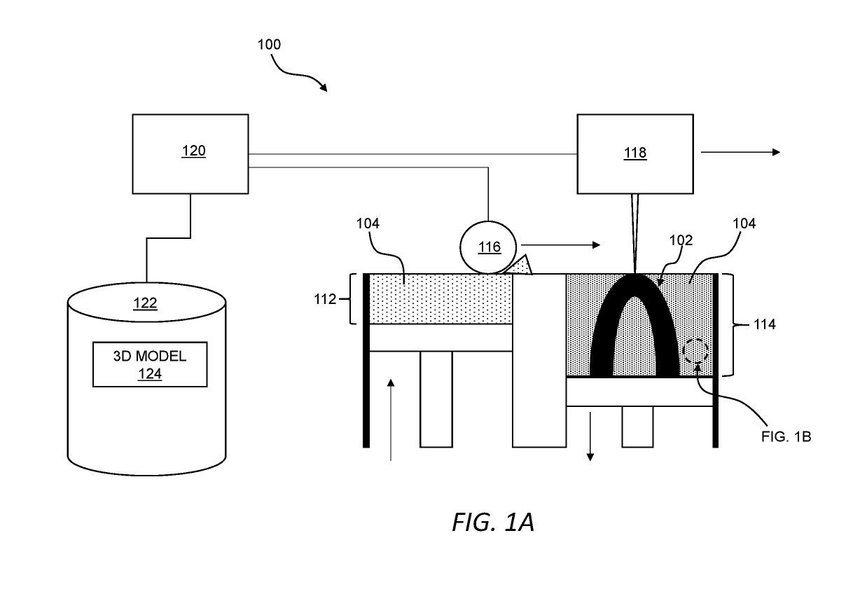

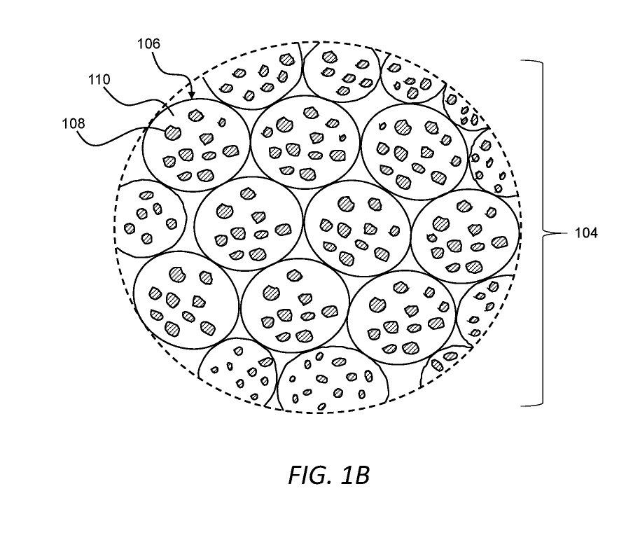

Referring now to FIGS. 1A and 1B, an additive manufacturing system 100 can be used to form a three-dimensional object 102 from a powder 104. As described in greater detail below, the powder 104 can include granules 106, and each granule 106 can include an agglomeration of first metallic particles 108 in at least one component 110 of a binder system. As also described in greater detail below, the granules 106 of the powder 104 can be spread into a plurality of sequential layers and, in each layer, the granules 106 can be reflowed along respective predetermined two-dimensional pattern. The at least one component 110 of the binder system in the reflowed granules 106 along the respective two-dimensional pattern in each layer can bind the first metallic particles 108 to one another and to one or more adjacent layers to form the three-dimensional object 102. The three-dimensional object 102 is a green part that, as described in greater detail below, can be subsequently processed (e.g., sintered) to form a finished part.

In general, the granules 106 can facilitate overcoming significant constraints associated with three-dimensional fabrication techniques that are based on spreading a powder and jetting a binder (e.g., binder jetting). For example, the granules 106 can be coarse enough to be adequately spread in each layer while the first metallic particles 108 agglomerated in the granules 106 can be fine enough to be sintered into a high-density finished part. Thus, the granules 106 can facilitate fabricating the three-dimensional object 102 from the first metallic particles 108 having a size range that, without agglomeration, is not suitable for spreading. Further, or instead, agglomeration of the first metallic particles 108 in the granules 106 can reduce risks (e.g., pyrophoric risk) associated with ultrafine particles that are not agglomerated. Additionally, or alternatively, as compared to a system in which a binder is delivered to a powder bed exclusively from a printhead, the inclusion of at least one component 110 of a binder system in the granules 106 can reduce, or even eliminate, the amount of binder required to be delivered to each layer from a printhead. Such a reduction or elimination of the amount of binder required to be delivered from a printhead can reduce downtime associated with one or more of repair, maintenance, and replacement of the printhead. The result, therefore, of the use of granules 106 to deliver the at least one component 110 of the binder system can be increased throughput of three-dimensional objects.

The additive manufacturing system 100 can include a powder supply 112, a powder bed 114, a spreader 116, and a printhead 118. The spreader 116 can be movable from the powder supply 112 to the powder bed 114 and along the powder bed 114 to spread successive layers of the powder 104 across the powder bed 114. The printhead 108 can be movable (e.g., in coordination with movement of the spreader 106) across the powder bed 104, and the printhead 108 can include one or more orifices through which a liquid can be delivered from the printhead 108 to each layer of the powder 104 along the powder bed 114. As described in greater detail below, the liquid can interact with the at least one component 110 of the binder system in the granules 106 to reflow the granules 106 along a respective predetermined two-dimensional pattern in each layer.

The spreader 116 can include, for example, a roller rotatable about an axis perpendicular to an axis of movement of the spreader 116 across the powder bed 114. The roller can be, for example, substantially cylindrical. In use, rotation of the roller about the axis perpendicular to the axis of movement of the spreader 116 can spread the powder 104 from the powder supply 112 to the powder bed 114 and form a layer of the powder 104 along the powder bed 114. It should be appreciated, therefore, that the plurality of sequential layers of the powder 204 can be formed in the powder bed 114 through repeated movement of the spreader 116 across the powder bed 114.

The printhead 118 can define one or more orifices directed toward the powder bed 114 as the printhead 118 moves across the powder bed 114. The printhead 118 can include one or more piezoelectric elements. Each piezoelectric element can be associated with a respective orifice and, in use, each piezoelectric element can be selectively actuated such that displacement of the piezoelectric element can expel liquid from the respective orifice. In certain implementations, the printhead 118 can expel a single liquid formulation from the one or more orifices. In some implementations, however, the printhead 118 can expel a plurality of liquid formulations from the one or more orifices. For example, the printhead 118 can expel a plurality of solvents, a plurality of components of a binder system, or both from the one or more orifices.

In general, the printhead 118 can be controlled to deliver liquid to the powder bed 118 in predetermined two-dimensional patterns, with each pattern corresponding to a respective layer of the three-dimensional object 102. In certain implementations, the printhead 118 can extend axially along substantially an entire dimension of the powder bed 118 in a direction perpendicular to a direction of movement of the printhead 118 across the powder bed 118. For example, in such implementations, the printhead 118 can define a plurality of orifices arranged along the axial extent of the printhead 118, and liquid can be selectively jetted from these orifices along the axial extent to form a predetermined two-dimensional pattern of liquid along the powder bed 114 as the printhead 118 moves across the powder bed 114. Additionally, or alternatively, the printhead 118 can extend axially along less than an entire dimension of the powder bed 114 in a direction perpendicular to a direction of movement of the printhead 118 across the powder bed 114. In such implementations, the printhead 118 can be movable in two dimensions relative to a plane defined by the powder bed 114 to deliver a predetermined two-dimensional pattern of a liquid along the powder bed 114.

The additive manufacturing system 100 can further include a controller 120 in electrical communication with the powder supply 112, the powder bed 114, the spreader 116, and the printhead 118. The additive manufacturing system 100 can still further include a non-transitory, computer readable storage medium 122 in communication with the controller 110 and having stored thereon a three-dimensional model 124 and instructions for carrying out any one or more of the methods described herein. In use, one or more processors of the controller 120 can execute instructions to control z-axis movement of one or more of the powder supply 112 and the powder bed 114 relative to one another as the three-dimensional object 102 is being formed. For example, one or more processors of the controller 120 can execute instructions to move the powder supply 112 in a z-axis direction toward the spreader 116 to direct the powder 104 toward the spreader 116 as each layer of the three-dimensional object 102 is formed and to move the powder bed 114 in a z-axis direction away from the spreader 116 to accept each new layer of the powder 104 along the top of the powder bed 114 as the spreader 116 moves across the powder bed 114. Additionally, or alternatively, one or more processors of the controller 120 can control movement of the spreader 116 from the powder supply 112 to the powder bed 114 to move successive layers of the powder 104 across the powder bed 114.

Further, or instead, one or more processors of the controller 120 can control movement of the printhead 118 and delivery of liquid from the printhead 118 to deliver a respective predetermined two-dimensional pattern of the liquid to each new layer of the powder 104 along the top of the powder bed 114. In general, as a plurality of sequential layers of the powder 104 are introduced to the powder bed 114 and the predetermined two-dimensional patterns of the liquid are delivered to each respective layer of the plurality of sequential layers of the powder 104, the three-dimensional object 102 is formed according to the three-dimensional model 124 stored in the non-transitory, computer readable storage medium 122. In certain implementations, the controller 120 can retrieve the three-dimensional model 124 in response to user input, and generate machine-ready instructions for execution by the additive manufacturing system 100 to fabricate the three-dimensional object 102.

In general, the granules 106 can be discrete and flowable relative to one another to form the plurality of sequential layers of the powder 104. As used herein, unless otherwise specified or made clear from the context, flowable shall be understood to be used in the broadest sense to refer to whether or not the granules 106 move relative to one another. Thus, the flowability of the granules 106 can be a function of variables related to the granules 106, including, by way of example, any one or more of the size, size distribution, shape, surface area, density, and material of the granules 106.

In certain implementations, the granules 106 can be flowable relative to one another to form layers dimensioned to address countervailing considerations associated with accurately controlling dimensions of the three-dimensional object 102 and rapidly forming the three-dimensional object. For example, the granules 106 can be flowable relative to one another to form a layer having a thickness greater than about 30 microns and less than about 70 microns (e.g., about 50 microns).

In certain implementations, the granules 106 can be substantially spherical. As used herein, a substantially spherical granule shall be understood to a granule having a volume that is within ±30 percent a volume of a sphere defined by a maximum dimension of the respective granule. Additionally, or alternatively, the granules 106 can be formed through a spray drying process, and the granules 106 can be spherical to within manufacturing tolerances associated with such a process.

The granules 106 can have an average particle size of greater than about 20 microns and less than about 100 microns. The size of the granules 106 can be a function of, for example, the size and number of the first metallic particles 108 and the amount of the at least one component 110 of the binder system in each granule. In certain implementations, as described in greater detail below, metallic particles and/or one or more components of the binder system can be added to the powder bed 114 apart from the granules 106. In turn, the size of the granules 106 can be a function of such separately added metallic particles and/or one or more components of the binder system. For example, under otherwise comparable conditions, the size of the granules 106 can be smaller in implementations in which a higher fraction of the overall binder system is delivered from the printhead to the powder bed 114.

The first metallic particles 108 have an average particle size less than an average particle size of the granules 106, with the granules 106 generally acting as a carrier for spreading the first metallic particles 108 and, in certain instances, reducing certain safety risks associated with small particles. In certain implementations, the first metallic particles 108 can have an average particle size and a particle size distribution that is suitable for sintering to form a dense final part from the three-dimensional object 102. As a more specific example, the first metallic particles 108 can have an average particle size of greater than about 1 micron and less than about 5 microns. While such a size range can be useful in certain implementations, it should be appreciated that the first metallic particles 108 can have a smaller average particle size, such as, for example, an average particle size in a submicron range, such as a nanoparticle range (e.g., an average particle size greater than about 1 nanometer and less than about 100 nanometers).

In certain implementations, the first metallic particles 108 of the granules 106 can be a single material. For example, the first metallic particles 108 can be a single fine elemental powder one of tungsten, copper, nickel, cobalt, and iron. As another example, the first metallic particles 108 can be a single alloy powder (e.g., 316L stainless steel, 17-4 PH stainless steel, Co—Cr—Mo powder, or F15 powder). Additionally, or alternatively, the single material of the first metallic particles 108 can have an average particle size of greater than about 1 micron and less than about 5 microns. As used herein, a single material shall be understood to allow for impurities at levels associated with powder handling of metals and, further or instead, to allow for impurities in predetermined amounts of impurities specified for the three-dimensional object 102.

In some implementations, the first metallic particles 108 can include a plurality of materials. For example, the ratio of the plurality of materials in the first metallic particles 108 can be in a predetermined ratio suitable for alloying with one another to achieve a target alloy composition in the three-dimensional object 102. As an additional or alternative example, the first metallic particles 108 can include material components of stainless steel. As a more specific example, the first metallic particles 108 can include two or more of tungsten, copper, nickel, cobalt, and iron.

In implementations in which the first metallic particles 108 include a plurality of materials, the first metallic particles 108 can alloy to form a different material. For example, the first metallic particles 108 can include tungsten carbide having a submicron average particle size and cobalt having an average particle size of about 1 micron. These particles can be sintered to form a tungsten-carbide-cobalt based hard metal. As an example of such a tungsten-carbide-cobalt based hard metal, the first metallic particles 108 can include fine stainless steel and tungsten carbide and cobalt such that sintering the three-dimensional object 102 including these materials can form unique microstructures in a stainless-steel matrix. More specifically, these unique microstructures can be areas of tungsten carbide-cobalt in a stainless-steel matrix, with these areas having high hardness that can advantageously improve wear resistance of the finished part, as compared to the wear resistance of the finished part without such areas of high hardness.

Alternatively, the first metallic particles 108 can include materials that do not alloy with one another (e.g., tungsten and copper or molybdenum and copper). Additionally, or alternatively, the plurality of materials in the first metallic particles 108 can have different average particle sizes, with one of the materials being much finer than another one or more of the materials. Because sinter temperature of particles is a function of the size of the particles, differences in the sizes of the different materials included the first metallic particles 108 can be useful for achieving sintering at a target temperature.

In some implementations, the first metallic particles 108 can be lightly sintered to one another in the granules 106. Such light sintering can be useful, for example, for reducing the likelihood of crushing the granules 106 as the powder 104 is spread across the powder bed 114. Such resistance to crushing can be useful, for example, for achieving a desired distribution of the first metallic particles 108 in the powder bed 114. While the granules 106 can be formed to resist crushing in certain implementations, it should be appreciated that the granules 106 can be additionally or alternatively formed to resist breaking up as the granules 106 are flowed in the powder 104 and to break up as the granules 106 are spread across the powder bed 114 by the spreader 116.

The at least one component 110 of the binder system included in the granules 106 can be initially solid as the granules 106 to facilitate spreading the granules 106 across the powder bed 114 in sequential layers. Along a given layer, the granules 106 can be reflowed such that the at least one component 110 of the binder system moves along the layer and, alone or in combination with one or more other components of the binder system, adheres to one or more adjacent layers of the three-dimensional object 102 being formed in the powder bed 114. As used herein, reflowing of the granules 106 shall be understood to include any one or more of various different processes for increasing the flow of the at least one component 110 of the binder system (e.g., changing the at least one component 110 of the binder system from a substantially solid state to a substantially liquid state). As described in greater detail below, reflowing the at least one component 110 can be based on a chemical process. As also described in greater detail below, reflowing the at least one component 110 can additionally or alternatively be based on a thermal process.

In certain implementations, the at least one component 110 of the binder system can be soluble in one or more of water, hexane, alcohol, and limonene to reflow the at least one component 110 of the binder system in the granules 106. In certain implementations, the solvent alone can be jetted from the printhead 118 toward the powder bed 114 to reflow the granules 106 along a respective predetermined two-dimensional pattern in each layer. Additionally, or alternatively, a mixture of the solvent and one or more components of the binder system can be jetted from the printhead 118 to reflow the granules 106 along a respective predetermined two-dimensional pattern in each layer. For example, the liquid jetted from the printhead 118 to reflow the granules 106 can include a solvent and the at least one component 110 of the binder system that is included in the granules 106 such that the liquid jetted from the printhead 118 supplements the amount of the at least one component 110 already present in the granules 106 in the powder bed 114. Further or instead, the binder system can be a multi-component system, and the liquid jetted from the printhead 118 to reflow the granules 106 can include another component of the binder system. Continuing with this example, the combination of the at least one component 110 already present in the granules in the powder bed 114 can reflow and become activated as a binder through exposure to the liquid jetted from the printhead 118.

The use of the at least one component 110 of the binder system to agglomerate the first metallic particles 108 in the granules 106 can have significant advantages with respect to the printhead 118. For example, because at least a portion of the binder system is already present in the granules 106 in the powder bed 114, less of the binder system is required to be delivered through the printhead 118. As a more specific example, in instances in which a target volume fraction of the binder system in the three-dimensional object 102 is 33 percent, about half of the volume fraction of the binder system can be introduced into the three-dimensional object 102 through reflowing the granules 106. Continuing with this example, the remainder of the volume fraction of the binder system can be introduced into the three-dimensional object through liquid jetted toward the powder bed 114 from the printhead 118. Additionally, or alternatively, in instances in which the binder system includes multiple components, the printhead 118 can be used to jet more easily handled components of the binder system. Thus, in general, bifurcation of the binder system between the granules 106 and a liquid jetted by the printhead 118 can, usefully extend the life of the printhead 118 and/or reduce maintenance requirements associated with the printhead 118.

The material of the at least one component 110 of the binder system in the granules 106 can be selected based one or more of several factors. For example, the material of the at least one component 110 of the binder system can be selected for stability in storage, transport, or both of the granules 106. Additionally, or alternatively, the material of the at least one component 110 of the binder system can be selected for safety with respect to handling the granules 106. Further, or instead, the material of the at least one component 110 of the binder system can be selected based on compatibility with a process (e.g., spray drying) used to form the granules 106. Still further or instead, the material of the at least one component 110 of the binder system can be selected based on compatibility with the first metallic particles 108. As an example of such compatibility, the at least one component 110 of the binder system can have a melt temperature less than a melt temperature of the first metallic particles 108 such that the first metallic particles 108 can remain solid over a range of temperatures in which the at least one component 110 of the binder system is melted. It should be appreciated that, with such a different in melt temperature, the first metallic particles 108 can remain solid as the granules 106 are reflowed over a certain temperature range. In some implementations, the at least one component 110 of the binder system can have a melt temperature of greater than about 100° C. such that, for example, the at least one component 110 of the binder system can be effectively separated from water through the use of temperature.

In certain implementations, a temperature difference between the melt temperature of the least one component 110 of the binder system and a burn off temperature of the at least one component 110 of the binder system can be between about 100° C. and about 300° C. This range can provide an operating window useful for sintering the three-dimensional object 102. For example, within this range the at least one component 110 of the binder system can be present in a melted form in the three-dimensional object 102 before the at least one component 110 is burned off (e.g., during a sintering process), thus maintaining the shape of the three-dimensional object 102 as the three-dimensional object 102 exposed to increasing temperature (e.g., in a furnace) to sinter the first metallic particles 108. As the first metallic particles 108 are sintered to one another and/or to other particles, the at least one component 110 of the binder system can be burned off.

In some implementations, the at least one component 110 of the binder system can include an organic binder such as, for example, an organic binder that is soluble in water or other liquid jetted from the printhead 118. Additionally, or alternatively, the at least one component 110 of the binder system can include one or more polymers. Examples of such polymers include polyethylene glycol (PEG), polyethylene, polylactic acid, polyacrylic acid, polypropylene, and combinations thereof.

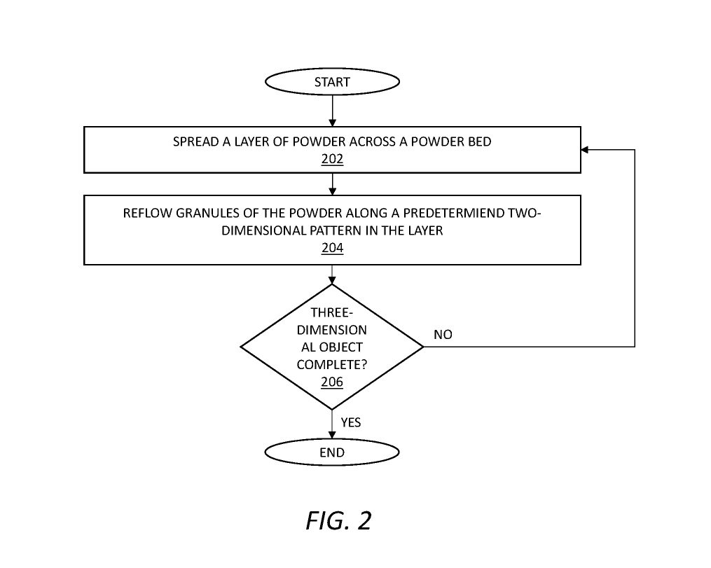

FIG. 2 is a flowchart of an exemplary method 200 of selectively reflowing granules of a powder to form a three-dimensional object. Unless otherwise specified or made clear from the context, the exemplary method 200 can be implemented using any one or more of the various different additive manufacturing systems described herein. For example, the method 200 can be implemented as computer-readable instructions stored on the storage medium 122 (FIG. 1A) and executable by the controller 120 (FIG. 1A) to operate the additive manufacturing system 100 (FIG. 1).

As shown in step 202, the exemplary method 200 can include spreading a layer of a powder across a powder bed. The powder can include any one or more of the granules described herein. Accordingly, the granules can include an agglomeration of first metallic particles in at least one component of a binder system.

As shown in step 204, the exemplary method 200 can include reflowing the granules along a predetermined two-dimensional pattern in the layer. The at least one component of the binder system from the reflowed granules can bind the first metallic particles in the layer to one another and to one or more adjacent layer. The result, therefore, of reflowing the granules along the predetermined two-dimensional pattern in the layer is to form a layer of a three-dimensional object.

As shown in step 206, the exemplary method can include repeating the steps of spreading a layer of the powder across the powder bed and reflowing the granules along a respective predetermined two-dimensional pattern in the layer for each layer of a plurality of sequential layers to form a three-dimensional object in the powder bed. It should be appreciated that the predetermined two-dimensional pattern in each layer can vary from layer to layer in the plurality of sequential layers, particularly in instances in which the three-dimensional object being formed from the predetermined two-dimensional patterns has a complex shape.

The granules can be reflowed along the predetermined two-dimensional pattern through the selective application of energy to the granules. That is, through the selective delivery of energy, the granules outside of the predetermined two-dimensional pattern can remain in a substantially solid form in the powder bed. Because the granules outside of the predetermined two-dimensional pattern associated with each layer remain substantially solid in the powder bed, the three-dimensional object can be removed from the remaining granules powder bed for subsequent processing, as described in greater detail below.

As an example, the selective delivery of energy chemically dissolving the at least one component of the binder system agglomerating the first metallic particles in the granules. For example, from a printhead moving across the powder bed, a liquid can be jetted toward the powder bed along a predetermined two-dimensional pattern associated with a respective layer. The liquid can include a solvent of the at least one component of the binder system. For example, in instances in which the at least one component of the binder system is water soluble, the solvent jetted from the printhead can include water. Additionally, or alternatively, the solvent jetted from the printhead can include one or more of hexane, alcohol, limonene, and combinations thereof in instances in which such solvents are suitable for dissolving the granules in the powder bed.

In certain implementations, the binder system can include a first component and a second component (e.g., different from the first component). The first component can agglomerate the first metallic particles in the granules, and the selective application of energy to the granules can include jetting the second component from the printhead to locally complete the binder system along the predetermined two-dimensional pattern. For example, the second component jetted from the printhead can cross-link the first component in the granules in the powder bed. Additionally, or alternatively, the first component and the second component of the binder system can have different melt temperatures such that, as the three-dimensional object is heated during a sintering stage, the first component and the second component can be removed from the three-dimensional object in stages. Example of the first component include polyethylene glycol, paracetic acid, and polylactic acid, and examples of the second component include another one of polyethylene glycol, paracetic acid, and polylactic acid. Thus, as a more specific example, the first component can include polyethylene glycol and the second component can include one of paracetic acid and polylactic acid.

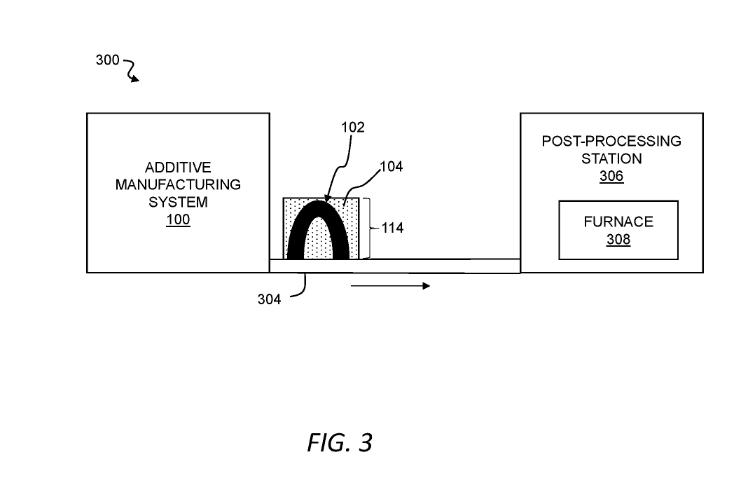

Referring now to FIGS. 1A, 1B, and 3, an additive manufacturing plant 300 can include the additive manufacturing system 100, a conveyor 304, and a post-processing station 306. The powder bed 114 containing the three-dimensional object 102, formed as a green part, can be moved along the conveyor 304 and into the post-processing station 306. The conveyor 304 can be, for example, a belt conveyor movable in a direction from the additive manufacturing system 100 toward the post-processing station. Additionally, or alternatively, the conveyor 30 can include a cart on which the powder bed 114 is mounted and, in certain instances, the powder bed 114 can be moved from the additive manufacturing system 100 to the post-processing station 306 through movement of the cart (e.g., through the use of actuators to move the cart along rails or by an operator pushing the cart).

In the post-processing station 306, the three-dimensional object 102 can be removed from the powder bed 114. The powder 104 remaining in the powder bed 114 upon removal of the three-dimensional object 102 can be, for example, recycled for use in subsequent fabrication of additional parts. Additionally, or alternatively, in the post-processing station 306, the three-dimensional object 102 can be cleaned (e.g., through the use of pressurized air) of excess amounts of the powder 104.

The three-dimensional object 102 can undergo one or more debinding processes in the post-processing station 306 to remove all or a portion of the binder system from the three-dimensional object 102. In general, it shall be understood that the nature of the one or more debinding processes can include any one or more debinding processes known in the art and is a function of the constituent components of the binder system. Thus, as appropriate for a given binder system, the one or more debinding processes can include a thermal debinding process, a supercritical fluid debinding process, a catalytic debinding process, a solvent debinding process, and combinations thereof. For example, a plurality of debinding processes can be staged to remove components of the binder system in corresponding stages as the three-dimensional object 102 is formed into a finished part.

The post-processing station 306 can include a furnace 308. The three-dimensional object 102 can undergo sintering in the furnace 308 such that the first metallic particles 108 melt combine with one another to form a finished part. Additionally, or alternatively, one or more debinding processes can be performed in the furnace 308 as the three-dimensional object 102 undergoes sintering. Further or instead, one or more debinding processes can be performed outside of the furnace 308.

While certain implementations have been described, other implementations are additionally or alternatively possible.

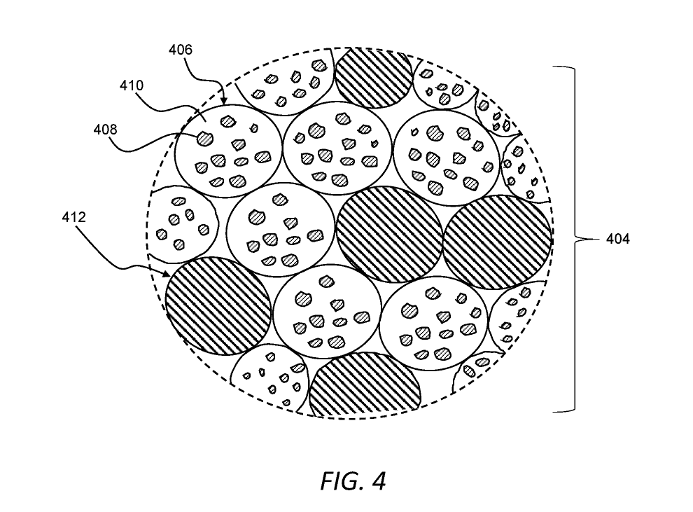

For example, while powders have been described as including only granules, it should be appreciated that powders of the present disclosure can include material in addition to granules. As an example, referring now to FIG. 4A, a powder 404 can include granules 406 and second metallic particles 412 separate from the granules 406 (e.g., the second metallic particles 412 can be unagglomerated) and mixed with the granules 406. In general, unless otherwise specified or made clear from the context, the granules 406 can be any one or more of the granules described herein and, thus, can include any one or more of the features of the granules 106 described with respect to FIG. 1B. More specifically, the granules 406 can include first metallic particles 408 agglomerated in at least one component 410 of a binder system, the first metallic particles 408 can include any one or more features of the first metallic particles 108 described with respect to FIG. 1B, and the at least one component 410 of the binder system can include any one or more features of the at least one component 110 of the binder system described with respect to FIG. 1B. Also, unless otherwise specified or made clear from the context, the powder 404 can be used in place of the powder 104 in the additive manufacturing system 100 (FIG. 1A) to form the three-dimensional object 102.

The granules 406 can be dispersed in the second metallic particles 408 in a flowable mixture that can remain mixed as the powder 404 is moved from a powder supply (e.g., the powder supply 112 in FIG. 1A) to a powder bed (e.g., the powder bed 114 in FIG. 1A) to form a layer of the powder. That is, the granules 406 and the second metallic particles 408 can have similar flow properties. The flow properties of the granules 406 and the second metallic particles 408 can be quantified through any one or more of various different known methods for quantifying powder. For example, the respective angles of repose of the granules 406 and the second metallic particles 408 can be useful as a proxy for the flow characteristics of each material. Thus, for example, the granules 406 can have a first angle of repose, the second metallic particles 408 can have a second angle of repose, and the first angle of repose and the second angle of repose can be substantially equal (e.g., differing from one another by less than about ±10 percent). With similar angles of repose, the granules 406 and the second metallic particles 408 can have similar flow characteristics and, accordingly, the granules 406 and the second metallic particles 408 can remain substantially uniformly mixed with one another as the powder 404 is moved. Thus, each layer of the powder 404 in a plurality of sequential layers can include a mixture of the granules 406 and the second metallic particles 408. The mixture of the granules 406 and the second metallic particles 408 in each layer can be, for example, substantially uniform in each layer. For example, the volume percentage of the second metallic particles 408 along each layer can vary by less than about 5 percent.

As the at least one component 410 of the binder system is selectively reflowed in the granules 406 along a predetermined two-dimensional pattern in each layer, the at least one component 410 can bind the first metallic particles 408 and the second metallic particles 412 in the layer to one another and to one or more adjacent layers. That is, as the granules 406 are reflowed, the at least one component 410 of the binder system can spread to the second metallic particles 412. The at least one component 410 of the binder system that spreads to the second metallic particles 412 can, therefore, bind the second metallic particles 412 along the predetermined two-dimensional pattern in each layer.

In general, the volume percentage of the binder system in a three-dimensional object formed from the powder 404 can be a target value (e.g., about one third) suitable for holding the three-dimensional object together through post-processing while also being removable from the three-dimensional object (e.g., through sintering) to form a dense part. Because at least a portion of the binder system is provided to the three-dimensional object through the granules 406 of the powder 404, it should be appreciated that achieving a target volume of the binder system in a three-dimensional object can be based on selecting relative volumetric percentages of the first metallic particles 408 agglomerated in the granules 406 of the powder, the at least one component 410 of the binder system, and the second metallic particles 412 that are unagglomerated in the powder 404.

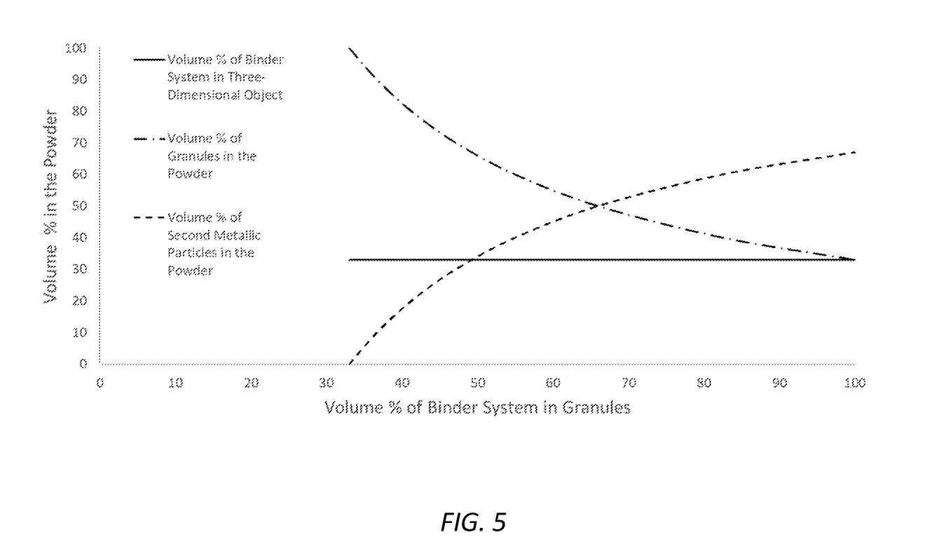

Referring now to FIGS. 4 and 5, FIG. 5 is a graphical representation of volumetric percentages of components of the powder 404 in implementations in which the binder system is introduced into a three-dimensional object exclusively through the granules 406 (e.g., the liquid delivered from the printhead does not include any portion of the binder system) and the target concentration of the binder in the three-dimensional object is 33 percent. In general, as shown in FIG. 5, as more unagglomerated second metallic particles 412 are added to the powder 404, more binder is required in the granules 406 to compensate for the unagglomerated second metallic particles 412 and, thus, maintain the overall percentage of the at least one component 410 of the binder system in the powder at the target 33 percent.

While FIG. 5 represents volumetric percentages of in implementations in which the binder system is introduced into a three-dimensional object exclusively through the granules 406, it should be appreciated that liquid jetted from a printhead (e.g., according to any one or more of the methods described herein) moving across the powder bed can include a portion of the binder system. The addition of a portion of the binder system through liquid jetted from a printhead can provide an additional degree of freedom for establishing volumetric relationships between components of the powder 404 to achieve a target binder concentration in the three-dimensional object being formed.

Referring again to FIG. 4, the powder 404 including the granules 406 and the second particles 412 can have a bimodal powder particle distribution. For example, the granules 406 can have a larger average particle size (e.g., about 50 microns) than an average particle size (e.g., about 7 microns) of the second particles 412. Such a bimodal powder particle distribution can be useful for facilitating, as an example, packing as the powder 404 is spread across a powder bed (e.g., across the powder bed 114 in FIG. 1A).

The first metallic particles 408 in the granules 406 can have an average particle size smaller than an average particle size of the second metallic particles 412. For example, the second metallic particles 412 can have an average particle size that is flowable while the first metallic particles 408 can have an average particle size that is now flowable without agglomeration in the granules 406. In certain instances, the second metallic particles 412 can have an average particle size in a microparticle range. Additionally, or alternatively, the first metallic particles 408 can have an average particle size of greater than about 1 micron and less than about 5 microns. Further, or instead, it should be appreciated that, because the size of the first metallic particles 408 is not limited by the ability to flow, the first metallic particles 408 can have an average particle size in a nanoparticle range in certain instances.

Differences in average particle size between the first metallic particles 408 and the second metallic particles 412 can be useful, for example, for sintering the first metallic particles 408 and the second metallic particles 412 separately. That is, because sinter temperature of a particle is a function of particle size, the smaller average particle size of the first metallic particles 408 can be useful for sintering the first metallic particles 408 before the second metallic particles 412 are sintered. As an example, the first metallic particles 408 can be sintered in a three-dimensional object (such as the three-dimensional object 102 in FIG. 1A) to reduce the likelihood of sagging in the three-dimensional object as temperature is further increased to sinter the second metallic particles 412.

The second metallic particles 412 that are unagglomerated in the powder 404 can include any one or more of the materials described herein and, further or instead, can include materials that are not generally amenable to being formed into particle sizes small enough for agglomeration in the granules 406. That is, the material composition of the first metallic particles 408 and the second metallic particles 412 can include any combination of materials suitable for forming a target composition in a finished part.

In certain implementations, the first metallic particles 408 can include a first material, and the second metallic particles 412 can include a second material different from the first material. A three-dimensional object (e.g., the three-dimensional object 102 in FIG. 1A) formed from the powder 404 including such different materials can include particles dispersed in each layer, with the particles in each layer including a plurality of materials (e.g., first material, the second material, and, optionally, one or more additional materials). These particles can be bound to one another and to one or more adjacent layers by a binder system including the at least one component 410 of the binder system. Continuing with this example, the three-dimensional object formed from the powder 404 including the granules 406 and the second metallic particles 412 and having a plurality of materials (e.g., the first material and the second material) in each layer can be sinterable to form a brown part having microstructures including at least one of the plurality of materials (e.g., the first material) distributed in a matrix of at least another one of the plurality of different materials (e.g., the second material). These microstructures are not achieved by mixing particles of different materials together with one another in a powder and, thus, are an advantage of a fabrication process in which the granules 406 including the first metallic particles 408 of a first material are reflowed in a mixture including the second metallic particles 412 of a second material. For example, microstructures achievable in a brown part formed from the powder 404 including the first metallic particles 408 agglomerated in the granules 406 and further including the second metallic particles 412 can include areas of high hardness and high wear resistance well distributed in a matrix of a relatively softer phase at a macro scale. Additionally, or alternatively, the amount of the hard and wear resistant phase can be varied depending on the volume percentage of the granules 406 in the powder 404.

The first material of the first metallic particles 408 and the second material of the second metallic particles 412 can be alloyable with one another. That is, a three-dimensional object (e.g., the three-dimensional object 102 in FIG. 1A) including the first material and the second material can be sintered, and the first material and the second material bound together by a binder system in the three-dimensional object can alloy with one another to form an alloy including the first material and the second material in a finished part. The alloy in the finished part can have a target concentration based on, for example, the relative volumetric concentration of the first metallic particles 408 and the second metallic particles 412 in a powder bed in which the three-dimensional object is formed. For example, the first material and the second material can be alloyable with one another to form steel. As a more specific example, the second material can include one or more of iron and stainless steel (e.g., having an average particle size of greater than about 5 microns and less than about 25 microns). Further, or instead, the first material can include one or more of tungsten, carbide, tungsten carbide-cobalt, and molybdenum to form microstructures in a matrix of the second material to form zones of local hardness that can improve wear resistance.

The first material can include a metal matrix composite. As used herein, a metal matrix composite shall be understood to include a composite material including at least one metal and another material, which can include one or more of another metal, a ceramic material, or an organic compound. Thus, for example, a metal matrix composite useable as the first material can include a composite material including a metal and carbon. Accordingly, continuing with this example, the metal matrix composite of the first material can introduce carbon into an alloy to form an alloy having a target concentration of carbon.

The first material and the second material can, further or instead, have different hardness. As a specific example, the first material can have a first hardness, the second material can have a second hardness, and the second hardness can be less than the first hardness. Thus, in certain instances, the small size of the first metallic particles 408 can be useful for introducing a hard material into a three-dimensional object, particularly in instances in which relatively small volumetric concentrations of the hard material are required for a target alloy composition in a finished part formed from the three-dimensional object.

In certain implementations, an alloy formed from the first material of the first metallic particles 408 and the second material of the second metallic particles 412 can have a smaller grain structure than an alloy formed of the second material alone. In general, the size of the grain structure is associated with strength of the alloy. Accordingly, it should be appreciated that the reduction in grain size produced by the addition of the first metallic particles 408 can increase the strength of a metal including the second material.

While the first material of the first metallic particles 408 and the second material of the second metallic particles 412 have been described as being alloyable with one another, it should be appreciated that, in certain implementations, first material and the second material can be unalloyable with one another. For example, the first material can include one tungsten and the second material can include copper. Further or instead, the first material can include molybdenum, and the second material can include copper. More generally, in an unalloyable combination, the first material can include a metal matrix composite and, additionally, or alternatively, the first material can have a higher hardness than the second material.

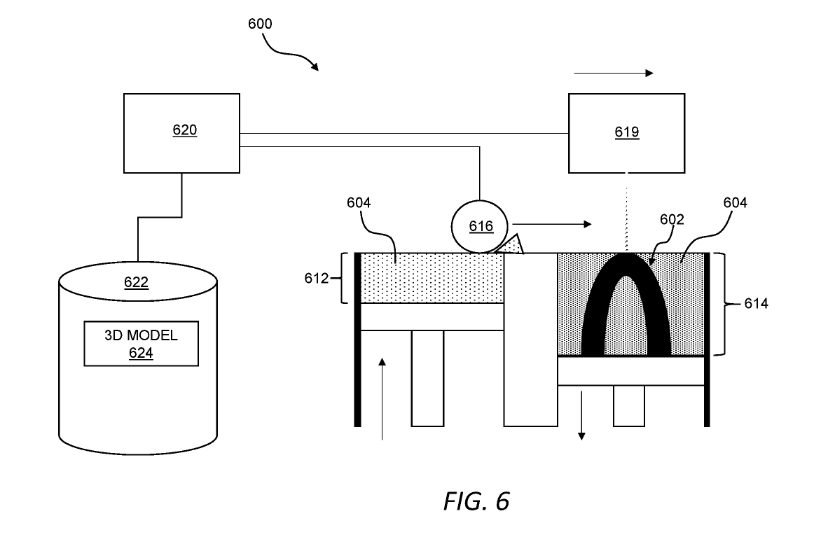

As another example, while reflowing granules has been described as including chemically dissolving the at least one component of the binder system, other types of energy can additionally or alternatively be delivered to the granules to reflow the granules. As an example, referring now to FIG. 6, an additive manufacturing system 600 can include an energy source 619 movable across a powder bed 614. Unless otherwise specified or made clear from the context, the additive manufacturing system 600 in FIG. 6 shall be understood to be operable in a manner analogous to the operation of the additive manufacturing system 100 in FIG. 1A. Accordingly, for the sake of concise and clear description, elements with “600”-series element numbers in the additive manufacturing system 600 in FIG. 6 shall be understood to be the same as corresponding elements with “100”-series element numbers in the additive manufacturing system 100 in FIG. 1A, unless otherwise specified or made clear from the context. More specifically, the additive manufacturing system 600 in FIG. 6 shall be understood to be analogous to the additive manufacturing system 100 in FIG. 1A, except that the printhead 118 is replaced with the energy source 619. Thus, for example, the controller 620 shall be understood to be analogous to the controller 120 and, therefore, can carry out any one or more of the methods described herein. Similarly, the spreader 616 shall be understood to be analogous to the spreader 116, the powder supply 612 shall be understood to be analogous to the powder supply 112, the powder bed 614 shall be understood to be analogous to the powder bed 614, etc. Further, unless otherwise specified or made clear from the context, the powder 604 shall be understood to include any one or more of the powders described herein and, thus, shall be understood to include one or more of the powder 104 (FIGS. 1A and 1B) and the powder 404 (FIG. 4).

The energy source 619 can thermally dissolve at least one component of the binder system in granules of the powder 604 with little to no charring or vaporization of the at least one component of the binder system. For example, the energy source 619 can include one or more of an electron beam, a laser, and directed infrared. In use, thermal energy from the energy source 619 can be directed toward the powder 604 in the powder bed 614 in a predetermined two-dimensional pattern in each layer of the powder 604. Along the predetermined two-dimensional pattern in each respective layer, heat from the energy source 619 can heat the least one component of the binder system in the granules of the powder 604 to a temperature greater than a melt temperature of the at least one component of the binder system and less than a burn off temperature of the at least one component of the binder system. Thus, heat from the energy source 619 can reflow the granules of the powder 604 along each layer to bind metallic particles in each layer to each other and to one or more adjacent layers to form a three-dimensional object. The use of the energy source 619 can, for example, reduce or eliminate the need to deliver a binder and/or a solvent to the powder bed 614 and, thus, for example, can reduce or eliminate the need to maintain a printhead and an associated supply of liquid.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the systems and methods described above may be embodied in any suitable transmission or propagation medium carrying computer-executable code and/or any inputs or outputs from same.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A powder for additive manufacturing of a three-dimensional object, the powder comprising:
first metallic particles; and
at least one component of a binder system, the first metallic particles agglomerated in the at least one component of the binder system in the form of discrete granules flowable relative to one another to form a layer having a thickness greater than about 30 microns and less than about 70 microns.

2. The powder of claim 1, wherein the discrete granules are substantially spherical.

3. The powder of claim 1, wherein the first metallic particles include a plurality of materials alloyable with one another.

4. The powder of claim 3, wherein the plurality of materials includes two or more of tungsten, copper, nickel, cobalt, and iron.

5. The powder of claim 1, wherein the first metallic particles in respective granules are lightly sintered to one another.

6. The powder of claim 1, wherein the at least one component of the binder system is water soluble to reflow the at least one component of the binder system in the discrete granules.

7. The powder of claim 1, wherein the at least one component of the binder system is soluble in one or more of hexane, alcohol, and limonene to reflow the at least one component of the binder system in the discrete granules.

8. The powder of claim 1, wherein the at least one component of the binder system includes an organic binder.

9. The powder of claim 1, wherein the at least one component of the binder system includes one or more polymers.

10. The powder of claim 9, wherein the at least one component of the binder includes one or more of polyethylene glycol, polyethylene, polylactic acid, polyacrylic acid, and polypropylene.

11. The powder of claim 1, wherein the at least one component of the binder system has a melt temperature of greater than about 100° C. and less than a melt temperature of the first metallic particles.

12. The powder of claim 1, further comprising second metallic particles, wherein the discrete granules are dispersed in the second metallic particles in a flowable mixture.

13. The powder of claim 12, wherein the second metallic particles have an average particle size greater than an average particle size of the first metallic particles.

14. The powder of claim 12, wherein the first metallic particles include a first material and the second metallic particles include a second material different from the first material and alloyable with the first material.

15. The powder of claim 14, wherein the first material has a higher hardness than the second material.

16. The powder of claim 14, wherein an alloy including the first material and the second material has a smaller grain structure than an alloy formed of the second material alone.

17. The powder of claim 14, wherein the second material and the first material are alloyable with one another to form steel.

18. The powder of claim 17, wherein the second material includes iron.

19. The powder of claim 17, wherein the first material includes one or more of tungsten carbide, tungsten carbide-cobalt, and molybdenum.

20. The powder of claim 12, wherein the first metallic particles include a first material and the second metallic particles include a second material different from the first material, the first material and the second material unalloyable with one another.
